(19) United States
(12) Patent Application Publication
(10) Pub. No.: US 2024/0344666 A1
(43) Pub. Date: Oct. 17, 2024

(54) Closure Element, Vehicle Subassembly, and Vehicle

(71) Applicant: Bayerische Motoren Werke Aktiengesellschaft, Muenchen (DE)

(72) Inventor: Timo GUTMANN, Bad Kohlgrub (DE)

(21) Appl. No.: 18/292,116

(22) PCT Filed: Jul. 20, 2022
(86) PCT No.: PCT/EP2022/070398

§ 371 Date: Jan. 25, 2024

(30) Foreign Application Priority Data
Jul. 26, 2021 (DE) 10 2021 119 227.7

(51) Int. Cl. F17C 13/06; F16K 17/38

(52) U.S. Cl. CPC F17C 13/06; F16K 17/38; F17C 2205/0332; F17C 2270/0168

(57) ABSTRACT

An arrangement including a pressure vessel system and a closure element. The pressure vessel system cover has an opening. The closure element is fastened in the opening and is configured to at least partially close the opening. The closure element includes a covering portion with at least one sacrificial portion and a fastening portion. The closure element is fastened to the pressure vessel system cover in a region of the opening via the fastening portion, sealing the covering portion with respect to the pressure vessel system cover. The at least one sacrificial portion is configured to be destroyed and thus at least partially expose a cutout in the covering portion when a temperature of the covering portion rises above a first temperature threshold value.

### BACKGROUND AND SUMMARY

The technology disclosed here relates to a closure element for at least partially closing an opening in a pressure vessel system cover, to a vehicle subassembly having such a closure element, and to a vehicle having the vehicle subassembly.

Pressure vessel systems for storing fuel as such are known. The provision of thermal pressure relief devices (TPRDs) for the release of pressure for pressure vessels is also known. If the triggering temperature of such a pressure relief device is exceeded, the pressure relief device causes the stored fuel to be discharged from the pressure vessel. In the case of a pressure vessel system arranged in the region of a vehicle floor, it can be provided that the pressure vessel system is placed behind or via a pressure vessel system cover, for example in the form of a floor panel, in order to protect the pressure vessel system, in particular the pressure relief device, against spray water, snow, stone impacts and/or dirt.

One object of the technology disclosed here is to at least reduce or overcome a disadvantage of a previously known solution or to propose an alternative solution. In particular, a preferred object of the technology disclosed here is to provide a closure element which can be produced relatively inexpensively and by means of which an opening in a pressure vessel system cover can be at least partially closed. Furthermore, an object of the present disclosure is to provide a corresponding vehicle subassembly and a corresponding vehicle. The advantageous effects of the technology disclosed here can afford further preferred objects.

This and other object(s) is/are achieved by the subject matter of this disclosure.

According to one aspect, what is proposed here is a closure element which is designed to at least partially close an opening in a pressure vessel system cover. The closure element comprises a covering portion with at least one sacrificial portion. Furthermore, the closure element comprises a fastening portion which is intended to fasten the closure element to the pressure vessel system cover in the region of the opening, sealing the covering portion with respect to the pressure vessel system cover. The at least one sacrificial portion is designed to be destroyed and thus at least partially expose a cutout in the covering portion when a temperature of the covering portion rises above a first temperature threshold value.

The closure element can be produced relatively easily and inexpensively, for example using an injection molding process. Furthermore, the closure element makes it possible to relatively easily close the opening in the pressure vessel system cover in order to reduce the ingress of dirt or liquids through the opening in the pressure vessel system cover. The closure element is distinguished by a relatively simple structure. At the same time, it offers an elegant and in particular effective solution for keeping the pressure vessel system cover closed during normal operation of the pressure vessel system and for at least partially opening it quickly when the pressure vessel system threatens to overheat, so that the heat can reach the thermal pressure relief device in controlled fashion.

Another advantage is that the dynamics of the heat transmission through the opening in the pressure vessel system cover can be defined relatively easily by means of the first temperature threshold value during the development of the closure element. Thus, for example, the sacrificial portion can be configured with a relatively low first temperature threshold value when the intention is to expose the cutout as quickly as possible, in order to convey the heat to the pressure relief device quickly. If, by contrast, the pressure vessel system cover provides high heat insulation, a comparatively higher first temperature threshold value can be selected, in order to delay the triggering of the pressure relief device.

In the closed state of the covering portion, in which the cutout is not exposed, the covering portion is preferably designed to fluid-tightly, in particular water-tightly or gas-tightly, close an inner region, in particular enclosed by the fastening portion, of the closure element in the initial state of the closure element (that is to say, in the undestroyed state after the closure element has been produced). If, by contrast, the closure element is in its open state, the cutout, which is preferably in the form of a through-hole, is open. In the open state, the closure element in the inner region is free of a phase boundary, preferably along a path extending through the cutout. This makes it possible, on the one hand, for heat radiation to be able to propagate through the closure element along the path substantially without damping. On the other hand, a fluid can flow out of the pressure vessel into the surrounding area through the cutout.

In an embodiment, the covering portion is plate-shaped. Along its (in particular entire) outer periphery, it can adjoin an inner surface of the fastening portion. Advantageously, the covering portion is fluid-tight at its boundary with the fastening portion. The covering portion can be integrally bonded to the fastening portion or formed monolithically with the fastening portion. The fastening portion and/or the covering portion may be elastic. The closure element is preferably made from a plastic, a thermoplastic and/or an elastomer.

In a preferred variant, the closure element is in the form of a plug. In this case, the fastening portion of the plug may be designed to fix the plug in the opening of the pressure vessel system cover in such a way that the covering portion is sealed with respect to the pressure vessel system cover adjacently to the opening. The closure element/the plug can thus be plugged into the opening relatively quickly and easily, in order to close it. As an alternative, the closure element may be in the form of a cap, which can be mounted on the pressure vessel system cover adjacently to the opening, for example. The fastening portion can extend around a periphery of the opening both when the closure element is in the form of a plug and when it is in the form of a cap, in order to seal the covering portion with respect to the pressure vessel system cover around the periphery.

The closure element preferably also comprises a conducting portion which is preferably arranged on a surface of the covering portion that is opposite the inner region. The conducting portion may comprise one or more projections which extends/extend away from the covering portion and thus can be designed to conduct heat radiation in the direction of the sacrificial portions. The projections may be at a spacing from the fastening portion and extend away from the surface of the covering portion transversely, in particular perpendicularly, to the surface of the covering portion. Each of the projections may be in the form of a fin, brush and/or pin. If the covering portion has multiple sacrificial portions, as explained below, the conducting portion may extend between at least two of the sacrificial portions as viewed along the covering portion. In this way, heat can be transferred to the sacrificial portions efficiently with a relatively simple configuration even when the covering portion is dirty.

For precise heat conduction, it is possible in particular to provide that the conducting portion is made at least partially from a metal. Most preferably, the conducting portion comprises a core made from a material with a first heat conductivity and a casing made from a material with a second heat conductivity, with the first heat conductivity being higher than the second heat conductivity. The casing may be made from the same material as a supporting portion, explained in more detail below and at least partially surrounding the cutout/cutouts, of the covering portion. In a particularly advantageous variant, the core is made from aluminum, in particular in the form of an aluminum foil or aluminum fin, which can be sheathed (encapsulated by injection molding) with the material from which the supporting portion is made.

The conducting portion can make it possible to conduct heat effectively from the surrounding area of the pressure vessel system cover to the covering portion and/or into the inner region when the covering portion is covered with a foreign body (for example dirt or snow). The conducting portion is preferably highly flammable. In a particularly preferred variant, the material of the conducting portion has a flash point which is lower than a flash point of the fastening portion, of the covering portion and/or of the sacrificial portion. In this way, the conducting portion can virtually act as a fuse for the sacrificial portion. It may be provided that the conducting portion is in direct contact with the sacrificial portion.

The already mentioned supporting portion of the covering portion preferably forms a frame, which is designed to bear the at least one sacrificial portion. Together with the sacrificial portion, the supporting portion can fluid-tightly close the inner region of the closure element when the sacrificial portion is intact in the starting state of the closure element. When the sacrificial portion, by contrast, is destroyed owing to the temperature rising above the first temperature threshold value, the supporting portion can remain intact and mechanically stiffen/stabilize the closure element as long as the temperature of the intact covering portion remains below a second temperature threshold value which is greater than the first temperature threshold value. In this context, intact (substantially undestroyed) means that the respective element (the sacrificial portion or the supporting portion) provides its function of partially closing the closure element. The supporting portion is configured to be destroyed only at a temperature above the second temperature threshold value.

The first temperature threshold value and the second temperature threshold value can each be a melting point or flash point of a material of the at least one sacrificial portion or of the supporting portion. The sacrificial portion can thus be designed to melt or burn at and above the first temperature threshold value, in order to expose the cutout. The first temperature threshold value is preferably at least 60° C. or at least 75° C. or at least 90° C. or at least 100° C. The first temperature threshold value is preferably also at most 150° C. or at most 140° C. or at most 125° C. The first temperature threshold value is most preferably between 70° C. and 95° C., in particular between 80° C. and 85° C.

The first temperature threshold value is preferably below a triggering temperature of the pressure relief device. Advantageously, the first and the second temperature threshold value can be defined by material properties (in particular material composition and thickness) of the sacrificial portion or of the supporting portion during the development of the closure element, so that the opening dynamics of the closure element can be very elegantly designed as required.

If it is desired for the closure element to be able to react as quickly as possible to a rise in the temperature of the surrounding area at the surface of the covering portion that is opposite the inner region, it is advantageously provided that the at least one sacrificial portion has a relatively low heat capacity. In particular, the heat capacity of the sacrificial portion can in this case be lower than the heat capacity of the supporting portion, in particular at most 50%, at most 30% or at most 15% of the heat capacity of the supporting portion. For example, the heat capacity of the sacrificial portion can be selected such that a rise in the temperature of the aforementioned surrounding area from 20° C. to twice the first temperature threshold value results in a rise in the temperature of the covering portion from 20° C. to the temperature threshold value within fewer than 30 seconds, in particular in between 10 and 15 seconds. In a preferred variant, these numerical values are realized in that the at least one sacrificial portion is in the form of a membrane or a film or at least comprises the membrane or the film. In particular, it may be provided that the at least one sacrificial portion is made from plastic (preferably a polymer, elastomer and/or thermoplastic), woven fabric or paper.

If, by contrast, the closure element is to react slowly to a change in the temperature of the surrounding area at the surface of the covering portion that is opposite the inner region, the material of the sacrificial portion may have a relatively high heat capacity. In particular, the heat capacity of the sacrificial portion can in this case be higher than, for example be 2 to 4 times, the heat capacity of the supporting portion. In both of the aforementioned cases, the heat capacity can be predetermined by means of the mass and/or the specific heat capacity of the supporting portion or of the sacrificial portion.

In one variant of the closure element, the number of sacrificial portions is at least two, at least three or at least five. Each sacrificial portion can expose an associated cutout. The supporting portion can border each of these sacrificial portions/cutouts in its intact state, so that the sacrificial portions/cutouts can have a spacing from the fastening portion. The conducting portion may in this case extend between two or more adjacent sacrificial portions, in order to distribute the heat from the surrounding area at the surface of the covering portion that is opposite the inner region advantageously evenly over the mutually adjacent sacrificial portions.

The fastening portion may comprise an engagement device, which is configured to clampingly and sealingly receive a periphery of the opening of the pressure vessel system cover. In particular if the closure element is in the form of a plug, the engagement device may have a spring collar (spring lip) and a latching lug, which are designed to be supported on opposite sides of the pressure vessel system cover. The fastening portion is preferably made from an elastic material, in order to be able to be inserted reversibly into the opening of the pressure vessel system cover and fastened and also nondestructively removed from the pressure vessel system cover. This makes it possible to be able to quickly and easily exchange a closure element which is faulty or has been destroyed owing to a rise in the temperature above the first temperature threshold value for a new closure element. The flexibility on account of the exchangeability of the closure element also provides scope for adaptations after the pressure vessel system has been produced.

The fastening portion may also have a conducting element which extends transversely to the covering portion and is designed to conduct radiation propagating through the opening or a fluid propagating through the opening along the conducting element, when the closure element is fastened to the pressure vessel system cover. The conducting element is preferably formed as a conducting channel (in the form of a closed sleeve or half-shell-like sleeve). As an alternative, the conducting element may be in the form of a conducting plate which extends axially (transversely to the covering portion). The conducting element may in particular form a wall of the aforementioned inner region. A fixing device for a guide apparatus is also formed at an end of the closure element that is situated axially opposite the engagement device. The fixing device may also be in the form of a spring collar which is, however, as viewed in longitudinal section through the closure element, curved in the opposite direction to the spring collar of the engagement device and preferably smaller than the spring collar of the engagement device. In other words, as viewed in longitudinal section, the fixing device and the engagement device are each concave and have their open sides situated opposite one another.

The guide apparatus may be in the form of an extension of the conducting element/conducting channel. In particular, the guide apparatus may be designed to conduct heat radiation, that propagates through the cutout into the inner region, out of the conducting element, in particular in the direction of the thermal pressure relief device. The guide apparatus is preferably in the form of a pipeline or flexible line and can have a conical shape. The closure element may be fluid-tightly connected to the thermal pressure relief device at an end situated opposite the conducting element.

The closure element described in detail above is at this juncture also disclosed in combination with the mentioned pressure vessel system cover independently as an arrangement, with the closure element being in particular in its state fastened to the pressure vessel system cover. If the closure element is a plug, the plug can be inserted in the opening in this connection.

The vehicle subassembly proposed here comprises a pressure vessel system, which has at least one pressure vessel, a pressure line fluidically connected to the at least one pressure vessel and a thermal pressure relief device fluidically connected to the pressure line, a pressure vessel system cover which covers the pressure vessel system and has an opening adjacent to the pressure relief device, and at least one closure element, described in detail above, for the opening. The closure element can be fastened to the pressure vessel system cover in the region of the opening by means of the fastening portion, sealing the covering portion with respect to the pressure vessel system cover.

The opening is preferably arranged at a location of the pressure vessel system cover that is adjacent to the pressure relief device, so that the heat radiation propagating through the opening can reach the pressure relief device over a short distance. An outlet of the pressure relief device preferably faces in the direction of the opening, so that fluid (in particular gas) leaves the pressure relief device directly in the direction of the opening upon activation of the latter. A spacing between the opening and the pressure relief device may, for example, be less than five times or less than twice the diameter of the opening. If the pressure vessel system has multiple thermal pressure relief devices, an opening may be arranged adjacently to each pressure relief device in a similar way to the arrangement of opening and pressure relief device explained above. The pressure relief devices and/or the openings may be arranged in corner regions of the pressure vessel system.

All the openings, closure elements and pressure relief devices can have each of the features described above. If the closure element comprises the conducting element or/and the guide apparatus, it may extend in particular along a connecting axis between the opening and the outlet of the pressure relief device. In particular, the conducting element and/or the guide apparatus may fluidically connect the outlet of the pressure relief device to the opening along the connecting axis. The pressure vessel system cover is preferably part of a housing for the at least one pressure vessel, the pressure line and/or the thermal pressure relief device. In particular, it can be provided that the pressure vessel system cover is part of the underbody paneling of the vehicle subassembly. The pressure vessel system may, in addition to one or more pressure vessels, also have a battery store with a secondary battery, with the openings being arranged adjacently to the region of the pressure vessel system with the pressure vessels.

The vehicle proposed here is preferably a motor vehicle and has a vehicle subassembly that was described above. The vehicle subassembly is preferably arranged (in a central region) on the underbody of the vehicle between the wheels of the vehicle.

In other words, the technology disclosed here relates to a closure construction which, owing to suitable adjustment of its material composition, is configured such that it opens in good time in a predetermined way when subject to thermal loading. The closure construction can have a thermal delaying or accelerating effect owing to its structure. The closure construction may be in the form of a closure plug or closure cap and be protected against the accretion of ice or dirt. A channel-like extension of the closure plug into the pressure vessel system (for example in the direction of the TPRD/trigger valve) can also allow the triggering temperature to rise better or more quickly at the valve as required. Advantageously, the plug can also be located at the end of a funnel-shaped region which is intended to deflect the expelled gases.

The technology disclosed here will now be explained on the basis of the figures, in which:

### BRIEF DESCRIPTION OF THE DRAWINGS

FIG. 1 schematically shows a perspective view from the front of an embodiment of a closure element;

FIG. 2 schematically shows a perspective sectional view of the closure element from FIG. 1, with the closure element being mounted on the pressure vessel system cover;

FIG. 3 schematically shows a perspective sectional view of an embodiment of a closure element, with the closure element being mounted on the pressure vessel system cover;

FIG. 4 schematically shows a perspective front view of the closure element from FIG. 1, with the closure element being mounted on the pressure vessel system cover;

FIG. 5 schematically shows a detailed perspective partial view, looking toward the inner region of the closure element, of an embodiment of a vehicle subassembly; and

FIG. 6 schematically shows an overall view from below of the vehicle subassembly from FIG. 5.

### DETAILED DESCRIPTION OF THE DRAWINGS

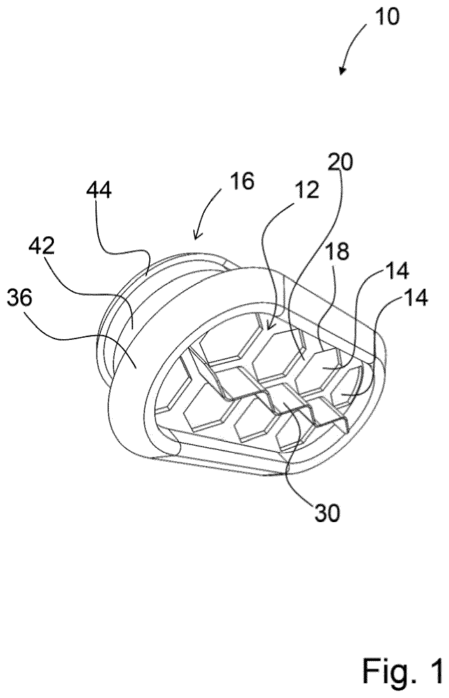

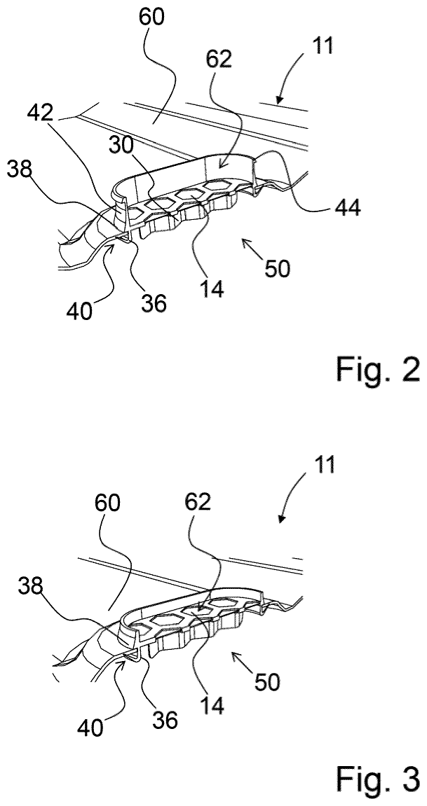

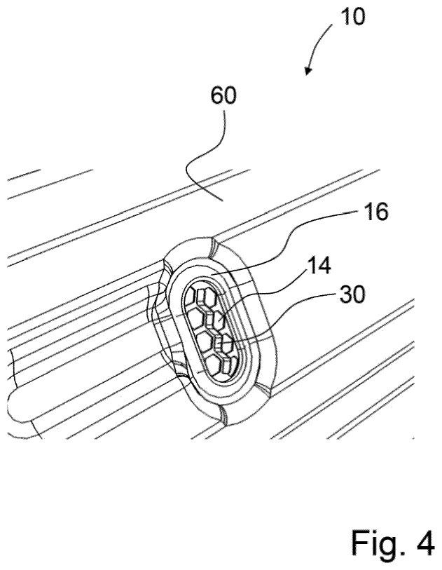

FIGS. 1, 2 and 4 show a closure element 10 for at least partially closing an opening 50 in a pressure vessel system cover 60 (cf. FIG. 2). The closure element 10 is in the form of a plug for the opening 50 here. While FIG. 1 only shows the closure element 10, FIG. 2 represents an arrangement 11 which comprises the closure element 10 and the pressure vessel system cover 60, with the closure element 10 being fastened in the opening 50 of the pressure vessel system cover 60.

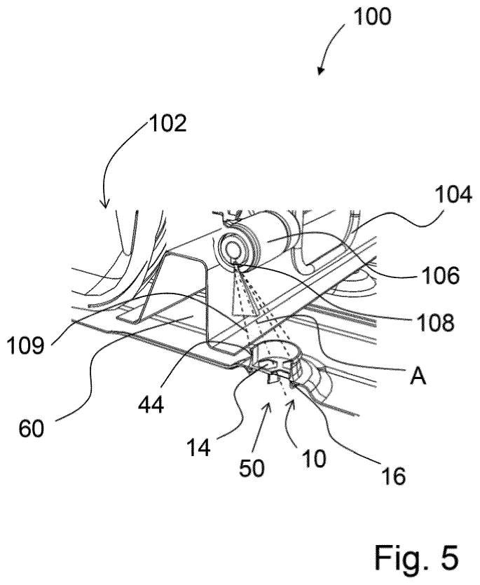

The closure element 10 comprises a covering portion 12, which crosses the opening and covers/closes it in the intact state, and a fastening portion 16, by means of which the closure element 10 is fastened in the opening 50. The fastening portion 16 is in the form of a sleeve and delimits a conducting element 42, which extends in the interior of the fastening portion 16/the sleeve. The conducting element can conduct heat radiation and/or a fluid. The conducting element 42 may in particular be in the form of a conducting channel and in this case extends between the covering portion 12, in which an engagement device 40 described below is formed, and a fixing device 44 for a guide apparatus 109, which fluidically connects the closure element 10 to a thermal pressure relief device (TRPD) (see FIG. 5). The guide apparatus 109 serves as extension of the conducting element 42.

In order to fluid-tightly connect the fastening portion 16 to the pressure vessel system cover 60, the fastening portion 16 is provided with the engagement device 40, which comprises a spring lip 36 and a latching lug 38. The spring lip 36 and the latching lug 38 extend partially or completely around the outer circumference of the fastening portion 16 and between them sealingly clamp a periphery of the opening of the pressure vessel system cover 60 in the state of the closure element 10 mounted in the opening 50. Here, the spring lip 36 rests on the pressure vessel system cover 60 on the outer side of the latter, which is illustrated at the bottom in FIG. 2. In order that the covering portion 12 extends substantially flush with the pressure vessel system cover 60 in the region of the opening 50, the latching lug 38 is arranged axially adjacently to the covering portion 12 with respect to the closure element 10.

The covering portion 12 is in the form of an elastic plate and, together with the fastening portion 16, delimits an inner region 62 of the closure element that is situated opposite the outer side. In particular, the covering portion 12 extends substantially coplanarly with the pressure vessel system cover around the periphery of the opening 50. The covering portion 12 along its outer periphery adjoins the fastening portion 16 and has multiple, in this case by way of example eight, sacrificial portions 14, two of which are identified as such in FIG. 1 for the sake of clarity. It is alternatively also possible to provide only one sacrificial portion 14. An axial direction of the closure element 10 extends substantially perpendicularly in relation to the covering portion 12 and, in the state inserted in the opening 50, perpendicularly in relation to the pressure vessel system cover adjacently to the opening 50.

Furthermore, the covering portion 12 comprises a supporting portion 20, which bears the sacrificial portions 14. The sacrificial portions 14 can be separate parts of the closure element 10 or formed in one piece/monolithically with one another. In the present case, the entire closure element 10 is produced monolithically (“from the same mold”) without joints between its individual regions. As an alternative, it is conceivable for only individual ones of the regions per se or combinations of two or more regions to be formed monolithically. In particular, the fastening portion 16 can be integrally bonded to or formed monolithically with the sacrificial portions 14, the supporting portion 20 and/or the covering portion 12. The covering portion 12 may likewise be integrally bonded to or formed monolithically with the sacrificial portions 14 and the supporting portion 20. Moreover, the covering portion 12 may be integrally bonded to or formed monolithically with a conducting portion 30, which is explained in more detail below. The sacrificial portions 14, the supporting portions and/or the fastening portion may be made from different materials.

The sacrificial portions 14 are each in the form of a flexible membrane (here made of a thermoplastic elastomer). They are in particular configured to be destroyed and thus at least partially expose a respective cutout 18 in the covering portion 12 when a temperature of the covering portion 12 rises above a first temperature threshold value. To this end, the sacrificial portions 14 are each thinner than the supporting portion 20 and have a lower melting point and a lower flash point than the rest of the covering portion 12. In this variant, the first temperature threshold value is a melting point of the material of the sacrificial portion 14. The first temperature threshold value is in the range between 7° and 95° C. and in this case is specifically approximately 85° C. (+/−3° C.).

By contrast to the sacrificial portions 14, the supporting portion 20 is designed to remain intact when the temperature of the covering portion 12 rises above the first temperature threshold value as long as the temperature of the covering portion 12 is lower than a second temperature threshold value. The second temperature threshold value may be, for example, 120° C. and is thus greater than the first temperature threshold value.

A conducting portion 30, here by way of example in the form of a metal fin encapsulated by injection molding/sheathed with the material of the covering portion, is formed centrally on the supporting portion 20 and extends from the supporting portion 20 axially and along a surface of the covering portion 12 that is situated opposite the inner region. The conducting portion 30 is arranged on the same side as the spring lip 36 and on a side situated opposite the latching lug 38 with respect to the opening 50. In the vehicle subassembly 100 according to FIG. 5, in the mounted state of the closure element 10 the conducting portion 30 is formed on the outer side of the pressure vessel system cover 60/of the housing and on the underside in the vehicle.

A closure element 10 from FIG. 3 differs from the closure element 10 from FIG. 1 only in that the former has a shorter conducting element 42 and no fixing device 44. In all other respects, the closure element 10 from FIG. 3 has all the features of the closure element 10 from FIG. 1.

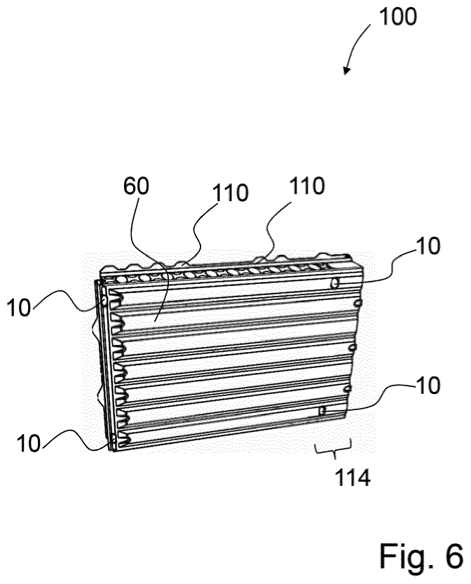

A vehicle subassembly 100 shown in FIGS. 5 and 6 is in particular intended for installation on the underbody of a vehicle, so that no additional underbody paneling is arranged below the vehicle subassembly 100. The vehicle subassembly 100 can be mounted on the vehicle underbody in particular via fastening flanges 110 formed on the pressure vessel system cover 60.

The vehicle subassembly 100 contains a pressure vessel system with multiple pressure vessels 102 (only one of which is illustrated in FIG. 5), a pressure line 104 fluidically connected to the pressure vessel 102, and multiple (in this case four) thermal pressure relief devices 106 each fluidically connected to the pressure line 104. Furthermore, the vehicle subassembly 100 has a pressure vessel system cover 60 which covers the pressure vessel system and has four openings 50, which are each arranged adjacently to one of the pressure relief devices 106. A closure element 10 is mounted in each opening 50. The pressure vessel system cover 60 is in the form of a housing, and therefore, in other words, the pressure vessel system is arranged in the interior of the housing. In addition to the pressure vessel system, a battery store is arranged in the housing in the region of a periphery 114.

As explained in detail above, each opening 50 is initially (in the intact state of the closure element) fluid-tightly closed by means of a closure element 10, so that no dirt, snow or spray water can enter the interior of the housing. What is described below applies for each of the four openings 50 and closure elements 10. When the pressure vessel system cover 60 comes into the vicinity of a heat source with a high temperature, for example a flame, the heat radiation emitted by the heat source is conducted in the direction of the covering portion 12, in particular the sacrificial portions 14, by means of the conducting portion 30. An input of heat from the heat source into the covering portion 12 causes the latter to heat up, that is to say the temperature of the covering portion 12 rises continuously starting at the temperature of the surrounding area.

As soon as the temperature of the covering portion 12 reaches the first temperature threshold value (melting point of the sacrificial portions 14), the sacrificial portions start to melt, before the supporting portion 20 begins to change (in particular to melt). Consequently, cutouts 18 form at the locations of the sacrificial portions 14, through which the heat radiation can propagate in a straight line and virtually unobstructed (without needing to negotiate a phase boundary) in the direction of the pressure relief device 106. The heat radiation is thus quickly and efficiently and also at the same time only locally conveyed to the pressure relief device 106, without the pressure vessels 102 being subjected to additional thermal loading. Consequently, an effective feed of the heat radiation to the pressure relief device 106, which represents a basic prerequisite for the correct function of the pressure relief device 106, can be ensured.

The effectiveness of this mode of operation can be additionally increased by providing, on the one hand, that the conducting element 42 extends along a connecting axis A between the opening 50 and an outlet 108 of the pressure relief device 106, in order to conduct the heat radiation de facto in the direction of the pressure relief device 106. On the other hand, the guide apparatus 109 which extends the conducting element 42, in particular if it tapers with an ever smaller spacing from the pressure relief device 106, can feed the heat radiation even more precisely in the direction of the pressure relief device 106 (cf. FIG. 5). Advantageously, this guide apparatus 109 may be designed to conduct the fluid flowing out of the pressure relief device 106 in the event of a pressure release directly in the direction of the opening 50, so that to the greatest possible extent this fluid does not flow in uncontrolled fashion into the housing.

For the sake of readability, this disclosure partially omits the expression “at least one” with simplifying effect. If a feature of the technology disclosed here is described in the singular or indefinitely (for example, the/a sacrificial portion, the/a covering portion, the/a fastening portion, the/a cutout, etc.) this is at the same time also intended to disclose a plurality thereof (for example the at least one sacrificial portion, the at least one covering portion, the at least one fastening portion, the/one cutout, etc.).

In the context of the technology disclosed here, the term “substantially” includes the respective exact property or the exact value and respective deviations which are not significant for the function of the property/the value, for example owing to manufacturing tolerances.

The preceding description of the present disclosure serves only for illustrative purposes and is not intended to limit the disclosure. Various changes and modifications are possible in the context of the disclosure without departing from the scope of the disclosure and its equivalents.

1.-15. (canceled)

16. An arrangement comprising:
a pressure vessel system cover with an opening; and
a closure element, fastened in the opening, configured to at least partially close the opening, wherein
the closure element comprises a covering portion with at least one sacrificial portion and a fastening portion,
the closure element is fastened to the pressure vessel system cover in a region of the opening via the fastening portion, sealing the covering portion with respect to the pressure vessel system cover, and
the at least one sacrificial portion is configured to be destroyed and thus at least partially expose a cutout in the covering portion when a temperature of the covering portion rises above a first temperature threshold value.

17. The arrangement according to claim 16, wherein the closure element is a plug or a cap.

18. The arrangement according to claim 16, wherein the covering portion has a plate-shaped form, and/or the covering portion around its outer periphery adjoins the fastening portion.

19. The arrangement according to claim 16, wherein the covering portion is integrally bonded to the fastening portion or is formed monolithically with the fastening portion.

20. The arrangement according to claim 16, further comprising: a conducting portion, which has a spacing from the fastening portion and extends away from a surface of the covering portion transversely to the surface of the covering portion.

21. The arrangement according to claim 16, wherein
the first temperature threshold value is a melting point or a flash point of a material of the at least one sacrificial portion, and/or
the first temperature threshold value is greater than 70° C. and/or less than 120° C., and/or
the first temperature threshold value is greater than 80° C. and/or less than 100° C.

22. The arrangement according to claim 16, wherein
the at least one sacrificial portion contains a membrane or a film, and/or
the at least one sacrificial portion is made from a flexible plastic, a flexible woven fabric or paper.

23. The arrangement according to claim 16, wherein
the covering portion has a supporting portion bearing on the at least one sacrificial portion, and
the supporting portion is configured to remain undestroyed when the temperature of the covering portion rises above the first temperature threshold value up to a second temperature threshold value higher than the first temperature threshold value.

24. The arrangement according to claim 16, wherein
the number of sacrificial portions is between at least 2 and at least 4, and
the sacrificial portions are designed to each expose an associated cutout.

25. The arrangement according to claim 16, wherein the fastening portion has an engagement device, which is configured to clampingly and sealingly receive a periphery of the opening of the pressure vessel system cover.

26. The arrangement according to claim 16, wherein the fastening portion has a conducting element, which extends transversely to the covering portion and that is configured to conduct radiation propagating through the opening or a fluid propagating through the opening along the conducting element, when the closure element is fastened to the pressure vessel system cover.

27. The arrangement according to claim 16, wherein
the fastening portion and/or the covering portion is elastic, and/or
the closure element is made from a flexible plastic, a thermoplastic, and/or an elastomer.

28. A vehicle subassembly comprising:
a pressure vessel system having a pressure vessel, a pressure line fluidically connected to the pressure vessel and a thermal pressure relief device fluidically connected to the pressure line; and
at least one arrangement according to claim 16, wherein
the pressure vessel system cover covers the pressure vessel system, and
the opening is adjacent to the pressure relief device.

29. The vehicle subassembly according to claim 28, wherein
the fastening portion has a conducting element, which extends transversely to the covering portion and is configured to conduct radiation propagating through the opening or a fluid propagating through the opening along the conducting element, when the closure element is fastened to the pressure vessel system cover, and
the conducting element extends along a connecting axis between the opening and an outlet of the pressure relief device.

30. A vehicle comprising a vehicle subassembly according to claim 28, wherein the vehicle subassembly is mounted on the underbody of the vehicle.
